(19) United States
(12) Patent Application Publication
(10) Pub. No.: US 2003/0077116 A1
(43) Pub. Date: Apr. 24, 2003

(54) Latching mechanism

(76) Inventor: Clint H. Kadel, Moultrie, GA (US)

Correspondence Address: J. W. Gipple, GIPPLE & HALE, P. O. Box 40513, Washington, DC, 20016, US

(21) Appl. No.: 09/982,033

(22) Filed: Oct. 19, 2001

(51) Int. Cl. F16B 1/00; F16D 1/00; F16L 23/00

(52) U.S. Cl. 403/339

(57) ABSTRACT

A latching mechanism for joining two instruments end to end, comprising two pommels extending rearwardly from instruments handles, each pommel having a bolt extending toward the other and each pommel having a socket to receive the bolt so extending and means to quickly and easily detach the two instruments so joined.

### FIELD OF INVENTION

The present invention is a latching mechanism for joining two instruments together, end to end, in a union which is stable and strong, and yet can be easily and quickly detached.

### BACKGROUND OF THE INVENTION

There are many situations in which it is desirable to join two instruments together to form a large unitary instrument. The one illustrated in the preferred embodiment involves swords.

Sword collectors often display their collections. The combination of two swords detachably joined, end to end makes an interesting display. The combination can also create a formidable weapon, which has two blades extending out from a double handle that can be grasped by the user and manipulated so as to apply the blades with effectiveness on both sides of the user; yet the combination can easily and quickly detached back into two separate swords, one in each hand.

Accordingly there is a need for a latching mechanism that can easily join two swords or other instruments into a strong and stable union which can as easily and quickly be detached.

### DESCRIPTION OF THE PRIOR ART

There are many latching mechanisms that employ principals similar to the present invention, but applicant is aware of no prior art which disclose a latching mechanism similar to that of the present invention nor used in similar manner or context.

### SUMMARY OF THE INVENTION

The present invention is directed to a latching mechanism for joining two instruments, end to end. It comprises two pommels which are the end pieces on both instruments, extending rearwardly from the handles of the instruments. Each pommel has a bolt extending toward the other and each pommel has a socket to receive the bolt so extending. One of the bolts has a notch. And the receptive socket, has a spring loaded linch pin which engages the bolt by springing into its said notch, when the bolt is pushed into the socket.

### BRIEF DESCRIPTION OF THE DRAWINGS

FIG. 1 is a front elevational view of two swords, joined end to end according to the invention.

FIG. 2 is a front perspective view of the two juxtaposed pommels of the invention.

FIG. 3 is a cross sectional view of rear pommel 6a with various internal shafts shown in phantom lines.

FIG. 4 is a cross sectional view through the mid center of pommels 6a and 6b with various components of the latching mechanism illustrated.

FIG. 5 is a side elevation view of the push pin 10.

FIG. 6 is a side elevation view of the linch pin 12.

FIG. 7 is a perspective view of the rocker arm 21.

FIG. 8 is a cross sectional view through the mid center of pommels 6a and 6b, joined in, latched relationship.

### DETAILED DESCRIPTION OF THE DRAWINGS

The present invention is directed to a latching mechanism for joining two instruments end to end in order to form a larger unitary instrument. The mechanism needs to provide a secure and stable union, which can yet be easily unlatched and the two instruments quickly separated. Although the latching mechanism of the invention is applicable to a variety of instruments, tools, weapons, etc., the preferred embodiment illustrated in the drawings applies the invention to swords.

The invention will be more fully appreciated by having specific reference to the drawings which illustrate a preferred embodiment thereof.

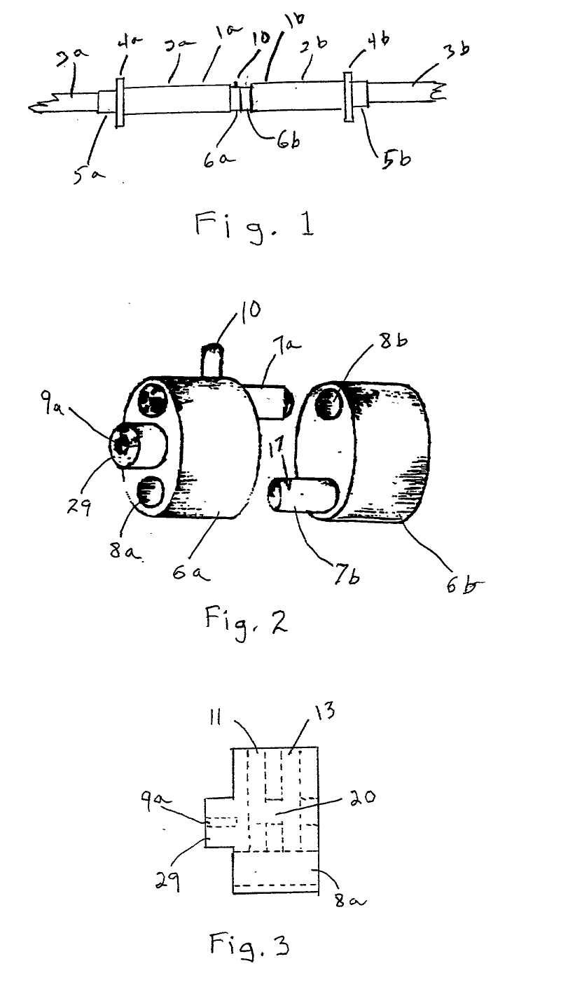

Directing attention to FIG. 1, swords 1a and 1b have handles 2a and 2b at the rear end of blades 3a and 3b and separated therefrom by hilts 4a and 4b. Between hilts 4a and 4b and blades 3a and 3b, are front pommels 5a and 5b. At the rear end of handles 2a and 2b, are rear pommels 6a and 6b, which are detachably but solidly joined together by the latching mechanism of the present invention. The top of push pin 10 protrudes above the surface of rear pommel 6a. Downward pressure on push pin 10 releases the latching mechanism as will be further explained in the following paragraphs.

FIG. 2 illustrates the two rear pommels 6a and 6b, juxtaposed. Both pommels have a bolt 7a and 7b extending rearwardly and toward the opposite pommel. The sockets 8a and 8b are dimensioned to receive bolts 7a and 7b. Both bolts 7a and 7b have rounded ends and their length is approximately the same as the length of sockets 8a and 8b. Bolt 7b has a notch 17 on its upper side. Threaded receptacles 9a and 9b, are dimensioned to receive threaded bolts (not shown in the drawings) which extend from the rear of handles 2a and 2b and are the means by which the rear pommels 6a and 6b are affixed to the rear handles 2a and 2b.

FIG. 3 illustrates rear pommel 6a, with its various internal shafts shown in phantom lines. In addition to the previously described socket 8a and threaded receptacle 9a, it has a push pin shaft 11, a linch pin shaft 13 and a center shaft 20.

It will be appreciated that the pommels 6a and 6b have an external appearance which is substantially identical, so that when joined they assume the appearance of being a unit. Furthermore they both have totally flat rear surfaces, other than bolts 7a and 7b. This seamless flat surface to flat surface association provides stability to the union created when the two pommels are joined by the latching mechanism of the present invention.

FIG. 4 illustrates the position and functioning of components in the latching mechanism of the present invention. Push pin 10 is positioned in push pin shaft 11, and has a slot 18 on its rear side. A threaded retaining bolt 19 is threaded into center shaft 20 so as to loosely engage slot 18. Push pin 10 can be moved up or down only to the extent allowed by the relationship of slot 18 with retaining bolt 19. Push pin 10, on its side opposite slot 18 has a shoulder 23 formed at the top of a second slot 25.

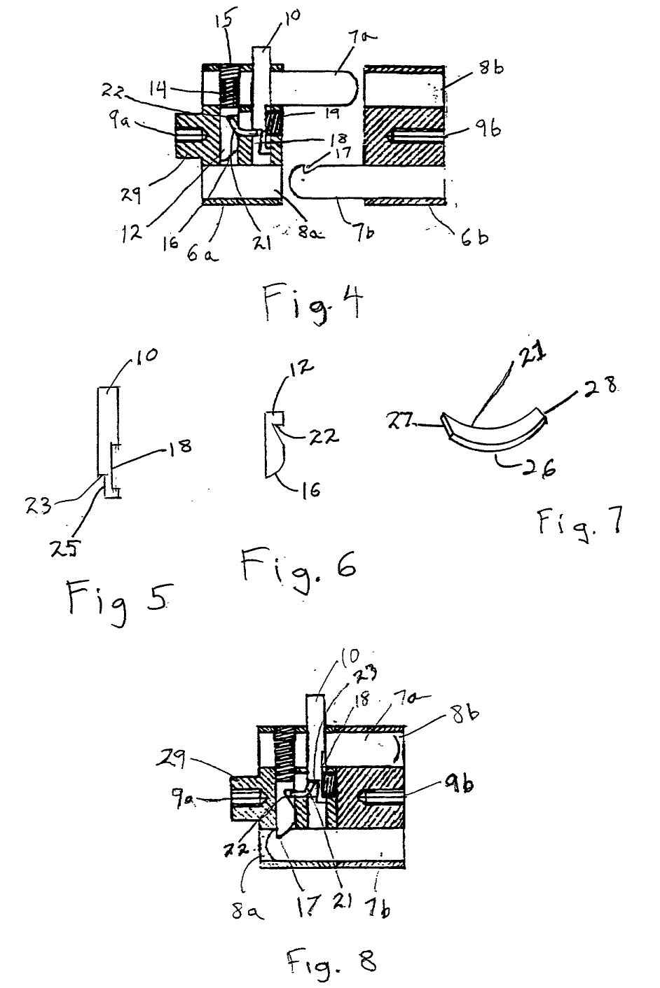

FIGS. 5., 6 and 7 more clearly illustrate the push pin 10, the linch pin 12 and the rocker arm 21.

At the bottom of linch pin shaft 13, there is the linch pin 12, which has on its lower end a beveled engagement tip 16. Toward its upper end it has a notch 22, which is adjacent to shoulder 23 on push pin 10. Above linch pin 12, in shaft 13 is a compressed coil spring 14, which exerts on downward pressure on linch pin 12. Above spring 14, in the shaft 13, is a threaded cap 15, which keeps the spring 14 from extending upwardly.

Positioned in that portion of center shaft 20, which extends between shoulder 23 and notch 22, is the rocker arm 21 which is arc shaped. FIG. 7 is a perspective view of the rocker arm 21, which has a bottom middle point 26, and upwardly extending opposite ends 27 and 28. The bottom middle point 26, of rocker arm 21 rests on the bottom of shaft 20. Its end 28 fits under and engages shoulder 23 on push pin 10. Its end 28 fits into and engages the notch 22 on linch pin 12. When static, the engagement tip 16 of linch pin 12, remains engaged with the notch 17, thus holding the two pommels 6a and 6b in a union. When activated, by downward pressure on push pin 10, shoulder 23 moves downwardly, causing the engaged end 28 of rocker arm 21 to move downwardly. This downward movement causes rocker arm 21 to pivot on bottom middle point 26, lifting end 27 upwardly. The upward movement of end 27, which is engaged in notch 22 lifts linch pin 12 upwardly, further compressing coil spring 14 and lifting tip 16 out of engagement with notch 17.

It should be appreciated that bolt 7b has a rounded end so that when it is pushed into the socket 8a, its rounded end will push pass tip 16 of the linch pin 12, causing it to temporarily move upwardly, compressing spring 14 until tip 16 aligns with notch 17 and it snaps into a solidly latched relationship.

Other modifications and alternatives to the herein described procedures and components will be apparent to those of ordinary skill in this art and are considered to fall within the scope of the claims defining this invention.

What is claimed is:

1. A latching mechanism for joining two instruments, end to end, comprising:
two pommels on the rear ends of the two said instruments
each of said pommels having a bolt that extends rearwardly toward the other pommel, and a corresponding socket to receive said bolt
means to engage said bolts in said sockets, and to thereby join the said pommels in a stable union
means to easily and quickly detach said bolts from said sockets

2. The latching mechanism of claim 1, wherein, one of said bolts has a notch and the said corresponding socket has a linch pin to detachably engage the notch.

3. The latching mechanism of claim 2, wherein, the said linch pin is interconnected with a push pin, in such a way that downward pressure upon said push pin lifts the said linch pin out of engagement with said notch.

4. The latching mechanism of claim 3, wherein the said linch pin is interconnected to said push pin by a rocker arm having a bottom middle point which functions as a fulcrum, and opposite ends engaging said linch pin and said push pin, so that downward movement of said push pin results in upward movement of said linch pin.

5. The latching mechanism of claim 2 wherein the said linch pin is spring loaded.

6. The latching mechanism of claim 3 wherein the said linch pin is spring loaded.

7. The latching mechanism of claim 4 wherein the said linch pin is spring loaded.

8. The latching mechanism of claim 1, wherein the two instruments are swords.
